(19) United States
(12) Patent Application Publication
(10) Pub. No.: US 2002/0073317 A1
(43) Pub. Date: Jun. 13, 2002

(54) System and method for protecting digital media

(75) Inventor: Laszlo Hars, Cortlandt Manor, NY (US)

Correspondence Address: Jack E. Haken, Corporate Patent Counsel, Philips Electronics North America Corporation, 580 White Plains Road, Tarrytown, NY, 10591, US

(73) Assignee: PHILIPS ELECTRONICS NORTH AMERICA CORPORATION.

(21) Appl. No.: 09/732,965

(22) Filed: Dec. 8, 2000

(51) Int. Cl. H04L 9/00

(52) U.S. Cl. 713/176

(57) ABSTRACT

A system and method for verifying digital recordings that have a plurality of tracks. The invention provides a protection system and method that verifies ownership of a digital recording by requiring the presence of the entire or significant portion of the medium (e.g., CD) as it existed when the digital recording was originally distributed.

Verification is accomplished by providing a mechanism that can generate a watermarked digital recording that comprises a plurality of first sections interleaved with a plurality of second sections, wherein the second sections include watermark information relating to data contained in the first sections. A compliant device is also provided that examines the watermarked digital recording and compares the data contained in the first sections with the watermark information to determine if any of the first sections have been removed or modified.

### BACKGROUND OF THE INVENTION

1. Technical Field

The present invention relates generally to security systems for digital recordings, and more particularly relates to anti-pirating schemes for controlling the copying, playing, and distribution of digital music.

2. Related Art

The popularity of both the Internet and digital media technologies (e.g., compact disks “CD's” and digital versatile disks “DVD's”) has created tremendous problems for copyright owners of digital media content. The ability to reproduce, play and transmit digital content has become readily available to anyone with a personal computer and access to the Internet. This ability has led to widespread abuses to the rights of copyright owners who are unable to stop the illegal reproduction of their works.

One particular area where copyright ownership is particularly abused involves the music industry. The illicit pirating of digital music across the Internet is causing immeasurable damages to the music industry. Heretofore, most music content has been packaged and stored in an open, unsecured format that can be read and processed by any digital media player or recorder, i.e., content can be readily reproduced, stored and transmitted. To address this, the music industry has sought to create a secure domain to control the rampant pirating of music.

One solution the music industry is exploring involves establishing standards for secure playback and recording devices that process specially encoded content. Numerous secure devices and systems have been proposed. For instance, U.S. Pat. No. 5,513,260, issued on Apr. 30, 1996, entitled, Method and Apparatus For Copy Protection For Various Recording Media, describes a system in which an authorization signature is required before a protected CD can be played. PCT application WO 99/60568, published on Nov. 25, 1999, entitled, Copy Protection Using Broken Modulation Rules, also discloses various anti-pirating systems. Each of these references is hereby incorporated by reference.

In addition, a group referred to as SDMI (Secure Digital Music Initiative), made up of more than 180 companies and organizations representing information technology, consumer electronics, telecommunication, security technology, the worldwide recording industry, and Internet service providers, is attempting to develop standards and architectures for secure delivery of digital music in all forms. Information regarding SDMI can be found at their website at <www.sdmi.org>.

One of the challenges with implementing compliant systems, such as those sought under SDMI, is that various competing requirements must be met. For instance, under SDMI: (1) people must be allowed to make an unlimited number of personal copies of their CDs if in possession of the original CD; (2) SDMI-compliant players must be able to play music already in a library; (3) SDMI must provide the ability to prevent large numbers of perfect digital copies of music; and (4) SDMI must prevent the distribution on the Internet without any compensation to the creator or copyright holder. Thus, SDMI requires that a limited form of copying must be allowed, while at the same time widespread copying must be prohibited.

Unfortunately, such competing requirements create opportunities for hackers and pirates to defeat the protection schemes of the systems. Accordingly, protection schemes that are difficult to defeat, but will meet the open requirements for initiatives such as SDMI, must be developed.

### SUMMARY OF THE INVENTION

This invention addresses the above-mentioned problems, as well as others, by providing a protection system and method that verifies ownership of a digital recording by requiring the presence of the entire or significant portion of the medium (e.g., CD), as it existed when the digital recording was originally distributed.

In a first aspect, the invention provides a system for marking a digital recording, wherein the digital recording includes a plurality of tracks, comprising: a mechanism for dividing the digital recording into a plurality of first sections interleaved with a plurality of second sections; a mechanism for calculating an identifier as a function of data contained in each of the plurality of first sections; and a watermarking mechanism for watermarking each of the plurality of second sections with information related to the identifier.

In a second aspect, the invention provides a system for verifying a digital recording by ensuring a completeness (or near-completeness) of the digital recording, comprising: a mechanism for reading a plurality of first sections from the digital recording and calculating a first verification identifier from data contained in the plurality of first sections; a mechanism for reading watermarks from each of a plurality of second sections from the digital recording; a mechanism for determining a second verification identifier from at least one of the watermarks; and a mechanism for comparing the first verification identifier and the second verification identifier.

In a third aspect, the invention provides a program product stored on a recordable media for marking a digital recording having a plurality of tracks that, when executed, comprises: means for dividing the digital recording into a plurality of first sections interleaved with a plurality of second sections; means for calculating an identifier as a function of data contained in each of the plurality of first sections; and means for watermarking each of the plurality of second sections with information related to the identifier.

In a fourth aspect, the invention provides a program product stored on a recordable media for verifying a digital recording that, when executed, comprises: means for reading a plurality of first sections from the digital recording and calculating a first verification identifier from data contained in the plurality of first sections; means for reading watermarks from each of a plurality of second sections from the digital recording; means for determining a second verification identifier from at least one of the watermarks; and means for comparing the first verification identifier and the second verification identifier.

In a fifth aspect, the invention provides a method for processing a digital recording, comprising the marking steps of: dividing the digital recording into a plurality of first sections interleaved with a plurality of second sections; calculating an identifier as a function of data contained in each of the plurality of first sections; and watermarking each of the plurality of second sections with information related to the identifier.

In a sixth aspect, the invention provides a watermarked digital recording having a plurality of tracks, comprising: a plurality of first sections interleaved with a plurality of second sections, wherein the second sections include watermark information relating to data contained in the first sections.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a block diagram of a verification system in accordance with a preferred embodiment of the invention.

FIG. 2 depicts a graphical representation of a digital recording having a plurality of tracks.

FIG. 3 depicts a graphical representation of the digital recording of FIG. 2 further containing watermarked information in accordance with the invention.

### DETAILED DESCRIPTION OF THE INVENTION

1. Overview

The present invention provides a system and method for protecting digital recordings from illicit processing. The term “processing,” as used herein, may include any type of reproduction, transmission, playback, modification, etc., of the digital content. The term “digital content” may include any type of information, data, music, video, multimedia, etc., that can be stored in a digital format. The described embodiments accomplish protection by requiring a complete, or significantly complete, data set of the digital recording to be present before processing can occur. For example, in the music industry, music is typically delivered on an audio CD that comprises a collection of tracks or songs. This invention would thus provide a system and method requiring the complete, or significantly complete, collection of tracks to be present before processing. Since illicit music copying is often limited to a small subset of the songs on a CD, the ability to illegally post and download individual songs from the Internet would be substantially limited.

Accordingly, the exemplary embodiments described herein require the presence of a significant or entire portion of the whole medium (i.e., collection of data as originally distributed) at the time of processing as proof of legal ownership. If a significant portion of the medium is not present, the processing of the digital recording can be aborted. Although one important application of this invention relates to the delivery of music content, it should be understood that the invention has applications to any type of digital recording that has a plurality of tracks. For the purposes of this disclosure, “a plurality of tracks” shall be defined to include any digital recording that has more than one individually usable or desirable segment.

2. Exemplary Embodiment

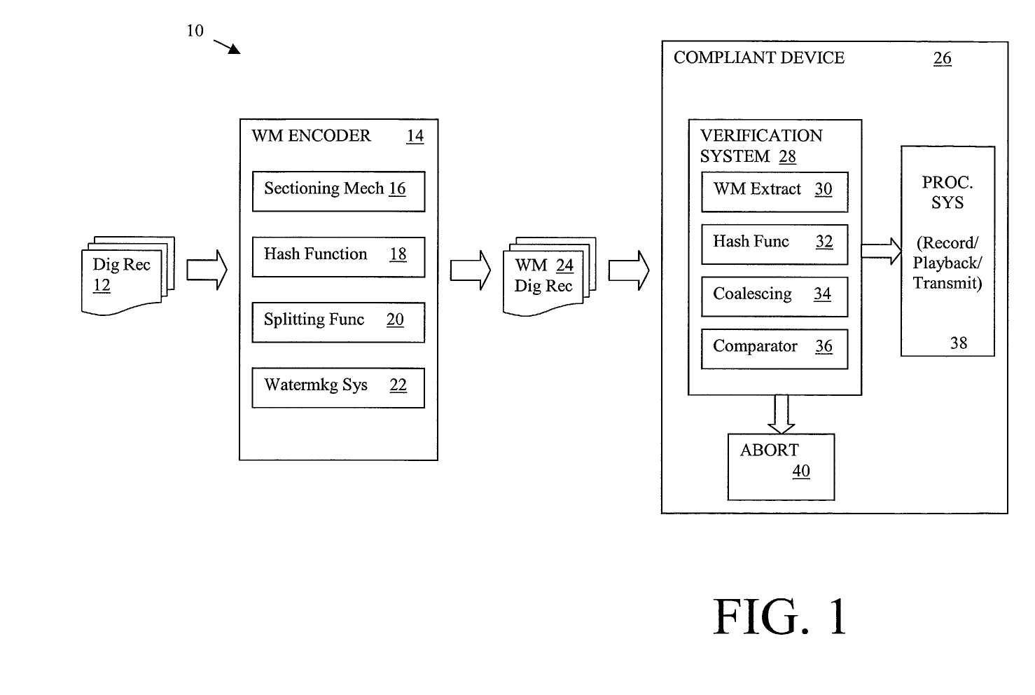

Referring now to the figures, FIG. 1 depicts a protection system 10 for marking and verifying a digital recording 12 having a plurality of tracks, such as a music CD. Marking is accomplished with a watermark encoder 14, and verification is accomplished with a verification system 28. In this embodiment, verification system 28 is shown as part of a compliant device 26 (e.g., a CD recorder or player), but could exist independently from such components.

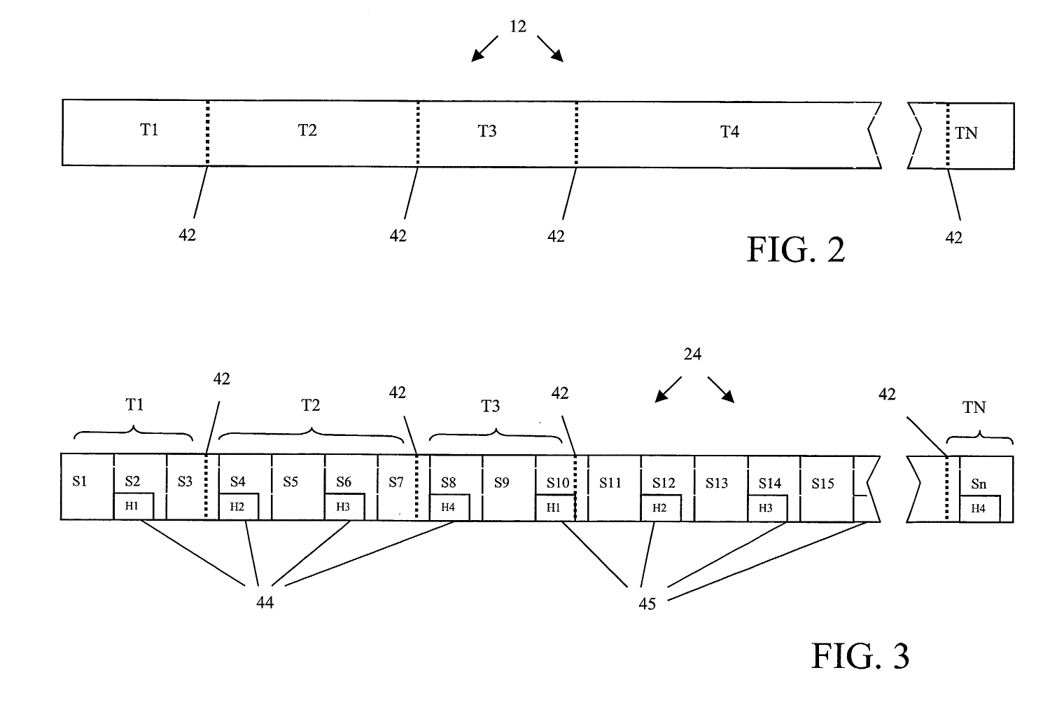

Watermark encoder 14 receives digital recording 12 and generates a watermarked digital recording 24. Watermark encoder 14 comprises various modules for marking digital recording 12. These modules include a sectioning mechanism 16, a hash function 18, a splitting function 20, and a watermarking system 22. The process of how these modules mark digital recording 12 is described in detail with regard to FIGS. 2 and 3. Once marked, a watermarked digital recording 24 is provided, which can be distributed or sold to the general public in a format that will allow compliant systems, such as compliant device 26, to limit illicit processing.

A compliant device 26, as shown in FIG. 1, may include any type of system for processing watermarked digital recording 24, e.g., a recording device for making copies of a watermarked CD. While there are no specific limitations placed on compliant device 26, it is understood that it generally comprises a system compliant with watermark encoder 14, i.e., it can analyze a watermark created by watermark encoder 14. Compliant device 26 includes a verification system 28 for verifying watermarked digital recording 24, a processing system 38 for performing the actual processing operation of the digital recording (e.g., record/playback/transmit), and an abort system 40 for aborting processing when the inputted digital recording is not properly verified.

Verification system 28 comprises various modules for verifying the watermark in watermarked digital recording 24. These modules may include a watermark extractor 30, a hash function 32, a coalescing function 34, and comparator 36. The operation of these modules is likewise described in more detail below with reference to FIGS. 2 and 3.

Referring now to FIG. 2, a graphical representation of a digital recording 12 is depicted that includes a plurality of N tracks (T1, T2, T3 . . . TN). Each track may represent, for example, a song on a CD. Each of the tracks are contiguously arranged and delimited by points 42. As shown in FIG. 2, digital recording 12 comprises no watermark information.

Referring now to FIG. 3, a watermarked digital recording 24 is shown which comprises the digital recording 12 of FIG. 2, along with incorporated watermark information, which is broken up into parts H1, H2, H3, etc. (For the purposes of this disclosure, each watermark part may be referred to individually as a watermark.) As can be seen, watermarked digital recording 24 includes the same N tracks as digital recording 12 delimited by points 42. In addition, it can be seen that watermarked digital recording 24 has been broken up into a plurality of n sections (S1, S2, S3 . . . Sn) that are independent of, and generally smaller than each of the plurality of tracks. The odd sections S1, S3, S5, etc., are left unchanged, while the even sections S2, S4, S6, etc., are marked with watermark parts H1, H2, H3, etc. Accordingly, watermarked digital recording 24 is comprised of a plurality of first sections (S1, S3, S5 . . . ) interleaved with a plurality of second sections (S2, S4, S6 . . . ), wherein the second sections include the watermark information. As will be described in further detail below, the watermark information included in the second sections relates to data contained in the first sections. In the example depicted in FIG. 3, the first sections are alternated with the second sections in an odd/even format. However, it is understood that the plurality of first sections and plurality of second sections can be interleaved in any manner; for example, the plurality of second sections may make up every third or fourth section. It should also be understood that no limitations exist with respect to the actual number of first and second sections used to implement the invention, and the n sections need not exactly align with the end of digital recording 12.

In addition, the plurality of seconds sections (S2, S4, S6, . . . ), which contain watermark information, are clustered into groups 44, 45, . . . , etc., with each group containing m sections. In the embodiment depicted in FIG. 3, m=4, so group 44 is comprised of sections S2, S4, S6 and S8; group 45 (not fully shown) is comprised of sections S10, S12, S14 and S16; a third group (not shown) would be comprised of sections S18, S20, S22 and S24; etc. The watermark information is repeated within each group 44, 45, . . . , etc. Thus, in this embodiment, each group receives watermark parts H1, H2, H3 and H4. It should be understood that the number of sections m in each group could be chosen as any integer. In this case, m is chosen as four, however, a typical value may range anywhere from between one and eight. The result is a watermarked digital recording 24 in which any group of second sections 44, 45, . . . , etc. can be analyzed to determine if the entire, or significant portion of, digital recording 12 exists. This process is described in detail below.

The process of watermarking watermarked digital recording 24 is described as follows with reference to both FIGS. 1 and 3. First, digital recording 12 is partitioned into n sections by sectioning mechanism 16. Each section is generally of a fixed length, e.g., 15 seconds. While there are no limitations placed on the length of each section, a preferable range comprises 8 to 30 seconds. Next, an identifier D is calculated by hash function “H” 18 as a hash of the data contained in each of plurality of first sections (i.e., the odd sections in this example) and is given by D=H(S1, S3, S5 . . . ). It is understood that hash function 18 may comprise any function or formula for generating a unique value D from a plurality of input values S1, S3, S5, etc. For instance, hash function 18 may simply comprise an adder that adds up all of the bit values contained in the first sections, but preferably comprises a fault tolerant hash function, which gives the same value if a small number of bits are changed due to, e.g., media or transmitter errors.

Next, splitting function 20 splits the calculated identifier value D into m parts H1, H2, H3 . . . Hm. It is understood that D may be split in any manner and m may equal any integer. For example, in the case where m=4, H1 may receive a least significant block of bits; H2 may receive the next least significant block of bits; H3 may receive the next least significant block of bits; and H4 may receive the most significant block of bits. Under such a scheme, if D=01101100, H1=00; H2=11; H3=10; and H4=01. Once the m parts are created, watermarking system 22 watermarks each group 44, 45, . . . , etc., of the plurality of second sections with the m parts. Any watermarking technique may be used. Thus, for example, as shown in FIG. 3, sections S2, S4, S6 and S8 in first group 44 receive parts H1, H2, H3 and H4, respectively; sections S10, S12, S14 and S16 in second group 45 also receive parts H1, H2, H3 and H4; etc. (Note that in the case where m=1, no splitting occurs, the entire calculated identifier resides in a single watermark part, and each group is made up of a single second section.)

The above process of mapping watermark parts WM into each ‘2i’th section may be expressed mathematically by the following formula:

WM₂ᵢ=H(1+(i mod m)).

However, it should be understood that the indexing of parts into the plurality of second sections could be accomplished with any other mapping scheme without departing from the scope of the invention.

Turning now to the process for verifying the watermark digital recording 24, reference is made to compliant device 26 of FIG. 1, and more particularly to verification system 28. The first step in verifying watermarked digital recording 24 is to read the plurality of first sections (in this example, the odd sections S1, S3, S5, etc.) and calculate a first verification identifier D′. D′ is calculated by hash function H′ 32, which should comprise the same calculation as hash function 18 used by watermark encoder 14. Accordingly, if all of the plurality of first sections are present, D′ should be the same as D.

Next, the m watermark parts from the first group 44 of second sections (e.g., in the above example where m=4, even sections S2, S4, S6, S8) are extracted using watermark extractor 30. Watermark extractor may use any technique for locating and extracting the watermarks. The m parts H1′, H2′, H3′, H4′ are then coalesced together using coalescing mechanism 34 to form a second verification identifier D″. Coalescing mechanism 34 assembles the m parts in an inverse manner in which the original identifier D was split apart by splitting function 20 of encoder 14. Thus, for example, if D was split apart as suggested above by assigning its least significant bits to H1, next least significant bits to H2, etc., coalescing mechanism would recombine bits in H1′, H2′, H3′, H4′ using the inverse scheme. Accordingly, if: H1′=00; H2′=11; H3′=10; and H4′=01; then, D″=H4H3H2H1 =01101100. (Note that in the case where m =1, no coalescing would be required, and the second verification identifier D″ would be equal to a single extracted watermark part.)

Finally, the first and second verification identifier D′ and D″ are compared using comparator 36. If they are equal, processing system 38 is allowed to proceed with processing of the watermarked digital recording 24. If they are not equal, further processing is aborted by abort system 40. The process can be repeated for other groups of sections (44, 45 . . . , etc.). By performing this test, the verification system 10 determines if one or more of the plurality of first sections and/or checked ones of the second sections are changed or left out.

If a secure hash is used, it is computationally infeasible for a hacker to find replacement odd sections that do not change the hash. Furthermore, a potential hacker will not be able to eliminate or replace the second sections since that would result in significant damage to the track being processed.

Another clear advantage of this invention is the relatively small amount of watermark information required. Assuming that each section is 15 seconds long, and a 32-bit hash value D is used, a typical four-minute song will have approximately 16 sections. Accordingly, the 32-bit hash will be dispersed among eight even sections requiring only four bits in each even section to create a watermark. The average number of watermark bits per section is therefore two.

A further advantage of the invention is if the watermark information gets extracted from only m sections of the song to be processed (carrying all parts of D) the system is still able to tell if the sections of the first plurality of sections are intact, that is, if the largest part of the recording is present. This is important in low-power devices, where watermark detection could require significant processing power.

As noted above, it is not necessary to interleave the plurality of first sections and plurality of second sections in an alternating odd/even manner. A variant would be to store the watermark information in every fourth section and use the other three sections to calculate the original identifier or hash value D. This would allow 3/4 of the digital recording content to be checked at processing. While the watermarks would be of twice the length (e.g., 8 bits), only one quarter of the sections would contain them.

As an additional variation, rather than starting a new group of watermark parts at every even mth section, new groups could be aligned to start with each track. This can be readily accomplished using the table of contents and it would ensure that at least one watermark section is available in each track for checking.

It is understood that the systems, functions, mechanisms, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which-when loaded in a computer system-is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

I claim:

1. A system for marking a digital recording, wherein the digital recording includes a plurality of tracks, the system comprising:
a mechanism for dividing the digital recording into a plurality of first sections interleaved with a plurality of second sections;
a mechanism for calculating an identifier as a function of data contained in each of the plurality of first sections; and
a watermarking mechanism for watermarking each of the plurality of second sections with information related to the identifier.

2. The system of claim 1, wherein the each of the plurality of first sections are interleaved in an alternating manner with each of the plurality of second sections.

3. The system of claim 1, further comprising a splitting mechanism for splitting the identifier into m parts such that each of the m parts comprises information related to the identifier.

4. The system of claim 3, wherein a set of m second sections form a group, and each second section within the group receives a unique one of the m parts of the identifier.

5. The system of claim 1, wherein the identifier is calculated as a hash of the data contained in the plurality of first sections.

6. The system of claim 1, wherein the digital recording includes a music recording, and the plurality of tracks include individual songs.

7. The system of claim 1, wherein a length of each section is less than a length of each track, and the number of sections is greater than the number of tracks.

8. A system for verifying a digital recording, comprising:
a mechanism for reading a plurality of first sections from the digital recording and calculating a first verification identifier from data contained in the plurality of first sections;
a mechanism for reading watermarks from each of a plurality of second sections from the digital recording;
a mechanism for determining a second verification identifier from at least one of the watermarks; and
a mechanism for comparing the first verification identifier and the second verification identifier.

9. The system of claim 8, wherein the second verification identifier is determined by coalescing a set of m watermarks read from the digital recording.

10. The system of claim 8, wherein the first verification identifier is calculated as a hash of the plurality of first sections.

11. The system of claim 8, wherein the plurality of first sections and plurality of second sections are interleaved in an alternating manner.

12. The system of claim 8, further comprising a mechanism for terminating a process when the first verification identifier and the second verification identifier are unequal.

13. A program product stored on a recordable media for marking a digital recording having a plurality of tracks that, when executed, comprises:
means for dividing the digital recording into a plurality of first sections interleaved with a plurality of second sections;
means for calculating an identifier as a function of data contained in each of the plurality of first sections; and
means for watermarking each of the plurality of second sections with information related to the identifier.

14. The program product of claim 13, further comprising means for splitting the identifier into m parts such that each of the m parts comprises information related to the identifier.

15. The program product of claim 14, wherein a set of m second sections form a group, and each second section within the group is watermarked with a unique one of the m parts of the identifier.

16. The program product of claim 13, wherein the identifier is calculated as a hash of the data contained in the plurality of first sections.

17. A program product stored on a recordable media for verifying a digital recording that, when executed, comprises:
means for reading a plurality of first sections from the digital recording and calculating a first verification identifier from data contained in the plurality of first sections;
means for reading watermarks from each of a plurality of second sections from the digital recording;
means for determining a second verification identifier from at least one of the watermarks; and
means for comparing the first verification identifier and the second verification identifier.

18. The program product of claim 17, wherein the second verification identifier is determined by coalescing a set of m watermarks read from the digital recording.

19. A method for processing a digital recording, the method comprising:
marking the digital recording with the steps of:
dividing the digital recording into a plurality of first sections interleaved with a plurality of second sections;
calculating an identifier as a function of data contained in each of the plurality of first sections; and
watermarking each of the plurality of second sections with information related to the identifier.

20. The method of claim 19, wherein the dividing step interleaves each of the plurality of first sections in an alternating manner with each of the plurality of second sections.

21. The method of claim 19, wherein the calculating step splits the identifier into m parts such that each of the m parts comprises information related to the identifier.

22. The method of claim 21, wherein a set of m second sections form a group, and each second section within the group is watermarked with a unique one of the m parts of the identifier.

23. The method of claim 19, wherein the identifier is calculated as a hash of the data contained in the plurality of first sections.

24. The method of claim 19, further comprising the verification steps of:
reading the plurality of first sections and calculating a first verification identifier from data contained in the plurality of first sections;
reading at least one watermark from the plurality of second sections;
determining a second verification identifier from the at least one watermark; and
comparing the first verification identifier and the second verification identifier.

25. The method of claim 24, wherein the step of reading the at least one watermark reads m watermarks from a first group of second sections, and wherein the step of determining the second verification identifier coalesces the m watermarks.

26. The method of claim 24, comprising the further step of aborting processing of the digital recording when the first verification identifier and the second verification identifier are not equal.

27. A watermarked digital recording having a plurality of tracks, comprising:
a plurality of first sections interleaved with a plurality of second sections, wherein the second sections include watermark information relating to data contained in the first sections.

28. The watermarked digital recording of claim 27, wherein the second sections are clustered into groups, and the watermark information in each group can be coalesced to generate an identifier that equals a hash of the data contained in the first sections.
